(19) United States
(12) Patent Application Publication
(10) Pub. No.: US 2011/0248685 A1
(43) Pub. Date: Oct. 13, 2011

(54) INDUCTIVE CHARGING OF ELECTRICAL ENERGY STORAGE COMPONENTS

(75) Inventor: Zafarullah Khan, Kenner, LA (US)

(73) Assignee: SMARTSYNCH, INC., Jackson, MS (US)

(21) Appl. No.: 13/041,328

(22) Filed: Mar. 4, 2011

Related U.S. Application Data
(60) Provisional application No. 61/303,416, filed on Mar. 4, 2010.

(51) Int. Cl. H02J 7/00

(52) U.S. Cl. 320/167

(57) ABSTRACT

According to aspects of the present invention, systems and methods are provided for faster charging of electrical energy storage components such as supercapacitors while maintaining the safety limits. In one or more exemplary embodiments, a flyback transformer is used to provide constant energy charging to the supercapacitor several times faster than in conventional systems or methods, due to the high frequency output of the flyback transformer, while not exceeding the power output rating of the power supply. According to one embodiment, a cycle-by-cycle energy transfer limit is used to charge one or more supercapacitors.

### CROSS-REFERENCE TO RELATED PATENT APPLICATION

This application claims priority to and the benefit of, pursuant to 35 U.S.C. §119(e), U.S. Provisional Patent Application Ser. No. 61/303,416, filed Mar. 4, 2010, entitled “Inductive Charging,” by Zafarullah Khan, the disclosure of which is herein incorporated by reference in its entirety.

### TECHNICAL FIELD

Aspects of the present disclosure relate generally to the charging of electrical energy storage components. More particularly, aspects of the present disclosure relate to fast charging of supercapacitors.

### BACKGROUND

Batteries are useful for the purpose of storing electrical energy. The use of batteries is not particularly convenient and causes a number of problems for the users, such as environmental hazards, safety problems, maintenance costs, charge/discharge rate limitations, finite number of possible charge cycles, narrow operating temperature range, battery life, and need for continuous replacement. Growing demands of portable systems, which can overcome the above-mentioned problems including the large size for a given power output, lead to introduction of supercapacitors as a replacement of or supplement to batteries. Further, use of supercapacitors minimizes charge time and overall system size for a given power output.

Conventional supercapacitor charging methods involve some form of current limiter to limit the charging current applied to the supercapacitor. The current limiter controls the current between a supercapacitor and battery or any other power source, thus preventing flow of excess current, because a completely discharged supercapacitor appears like a short circuit to the charging circuitry due to its very low Equivalent Series Resistance (ESR).

The rate of energy transfer into the supercapacitor is given by the following equation:

$$\frac{d e}{d t} = V + I , \qquad ( 1 )$$

where de/dt is the rate of energy transfer in Joules/Sec, V is the instantaneous voltage across the super capacitor in Volts, and I is the value of the constant current limit in Amperes.

As can be seen from (1), the rate of energy transfer is very slow at low voltages when the current limit is applied, irrespective of the power output capability of the power supply that is providing the charging current. As a result, the charging time is very long, as can be seen from (2):

$$T = \frac{C \times V max}{I} , \qquad ( 2 )$$

where T is the time in seconds, V max is the final steady state voltage in Volts, C is the capacitance in Farads, and I is the constant current limit in Amperes.

The current limit I is set so that the maximum rate of energy transfer (at Vmax) does not exceed the power output capability of the power source 210. Thus,

$$I = \frac{P}{V max}$$

where I is the current limit, P is the power output capability of the power source, and V max is the final steady state voltage attained by the supercapacitor. Thus, in terms of power output capability of the power source 210 P, equation (2) can be written as:

$$T = C \times V max \times \frac{V max}{P} . \qquad ( 2 a )$$

Another disadvantage of using the current limited charging method is that it can only charge the Supercapacitor to a voltage lower than or equal to the voltage of the DC power source.

### SUMMARY

In one or more aspects, the present invention provides a solution to the above mentioned problems by employing a flyback transformer to provide constant energy charging at a rate equal to the power output capability of the power source, irrespective of the instantaneous voltage of the supercapacitor, using a cycle-by-cycle energy transfer limit to charge the supercapacitors at a constant rate of energy transfer, instead of a constant current limit as used by conventional systems.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a first system for inductive charging of an electrical energy storage component, according to one embodiment of the present invention.

FIG. 2 illustrates a second system for inductive charging of an electrical energy storage component, in accordance with one embodiment of the present invention.

FIG. 3 is a flow chart illustrating operational steps of a first method for inductive charging of an electrical energy storage component, in accordance with one embodiment of the present invention.

FIG. 4 is a flow chart illustrating operational steps of a second method for inductive charging of an electrical energy storage component, in accordance with one embodiment of the present invention.

FIG. 5 is a flow chart illustrating operational steps of a third method for inductive charging of an electrical energy storage component, in accordance with one embodiment of the present invention.

### DETAILED DESCRIPTION

Reference is now made in detail to the description of the embodiments of systems and methods for inductive charging of electrical storage components, as illustrated in the drawings. However, the present invention should not be construed as limited to the embodiments set forth herein; rather, these embodiments are intended to convey the scope of the aspects of the present invention to those skilled in the art. Furthermore, all “examples” given herein are intended to be non-limiting.

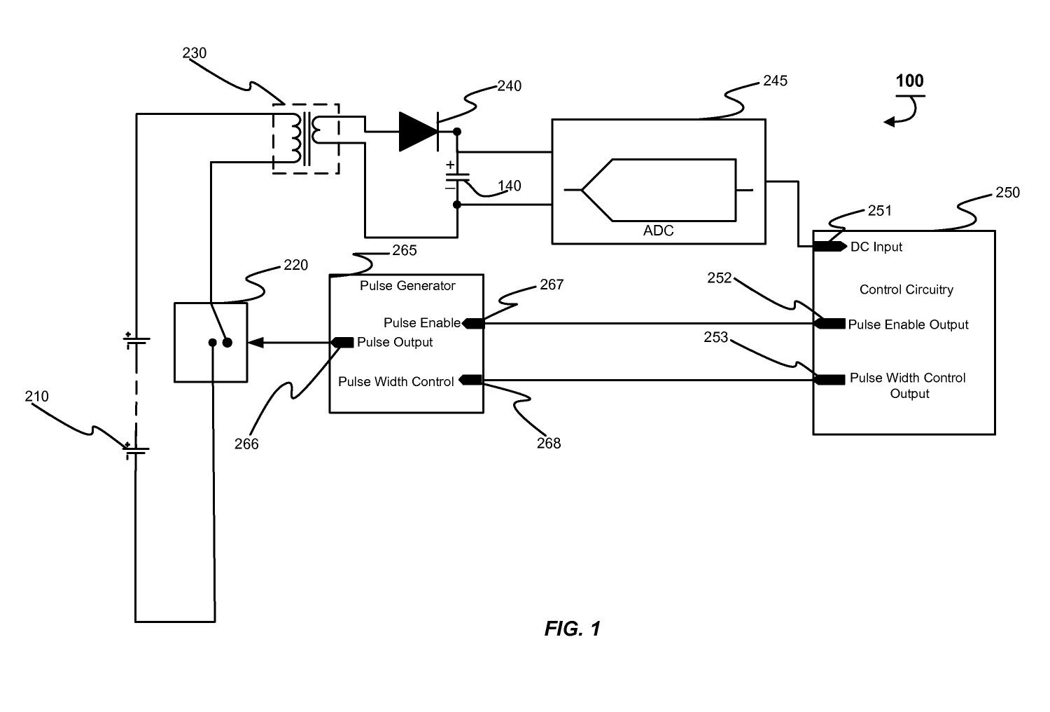

Referring now to the drawings, FIG. 1 illustrates a first system 100 for inductive charging of an electrical energy storage component, according to one embodiment of the present invention. As shown, a power source 210 provides a DC voltage and is operatively connected to a transistor switch 220. A flyback transformer 230 has a primary winding that is operatively coupled to the transistor switch 220 and the power source 210, with the secondary winding being operatively coupled to a fast switching diode 240. A supercapacitor 140 is operatively connected to the secondary winding and the switching diode 240. The switching diode 240 is operative to rectify a charging current flowing from the secondary winding to match the polarity of the supercapacitor 140. An analog-to-digital converter (ADC) 245 is operatively connected to the supercapacitor 140 and the switching diode 240 at an input. The ADC 245 is operative to measure the voltage of the supercapacitor 140 and provide a corresponding charge level signal. A programmable controller 250 has a DC voltage input 251 that is operatively coupled to an output of the ADC 245. The programmable controller 250 also has a pulse enable output 252 and a pulse width control output 253. A pulse generating circuit 265 has a pulse enable input 267 that is operatively coupled to the pulse enable output 252 of the programmable controller 250, a pulse output 266 that is operatively coupled to the transistor switch 220, and a pulse width control input 268 that is operatively coupled to the pulse width control output 253 of the programmable controller 250. The pulse generating circuit 265 is responsive to the charge level signal provided by the ADC 245, and includes a pulse generator that is operative to modulate the transistor switch 220 such that when the switch 220 is closed, current in the primary winding of the flyback transformer 230 ramps up, and when the switch 220 is open, energy stored in the primary winding is transferred to the secondary winding and the charging current flows into the supercapacitor 140.

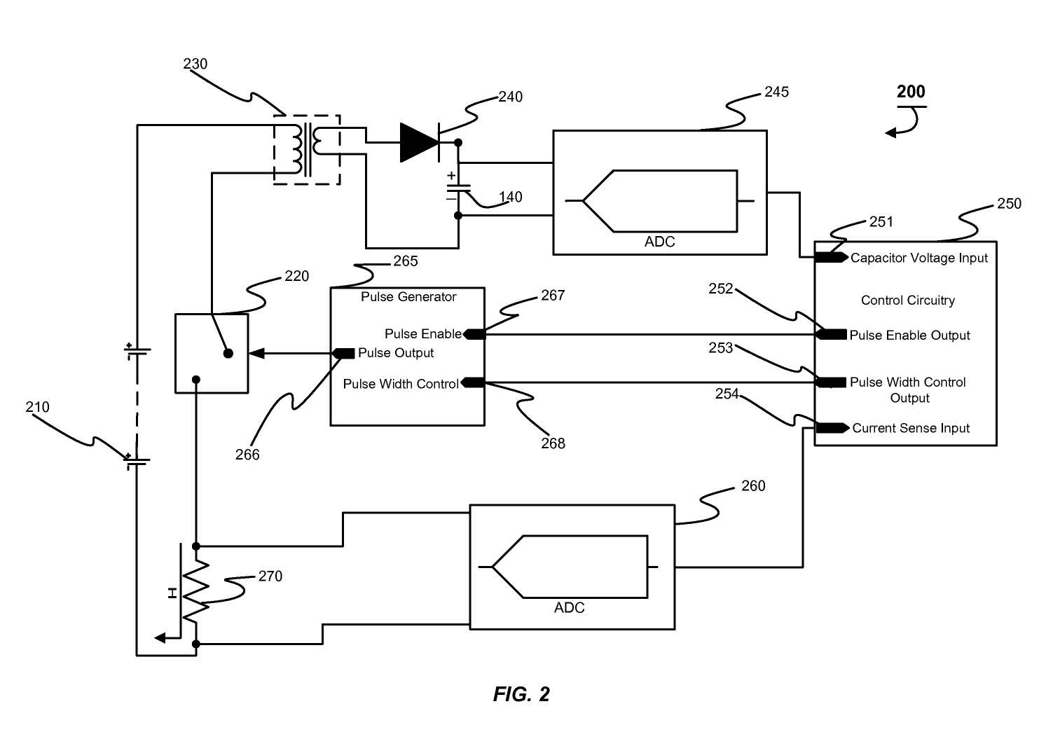

FIG. 2 illustrates a second system 200 for inductive charging of an electrical energy storage component, such as a supercapacitor 140, according to one embodiment of the present invention. As shown, the system 200 includes a power source 210, a transistor switch 220, a flyback transformer 230, and a switching diode 240. The system 200 includes an ADC 245 to measure the voltage of the supercapacitor 140, a pulse generator 265 to generate pulses used to modulate the switch 220, an ADC 260 to read the voltage across the current sensing resistor 270, and a programmable controller 250.

The charging time for the supercapacitor 140, using the flyback transformer 230 is given by the equation below:

$$T = C \times V \times \frac{V}{L \times {I}^{2} \times N} , \qquad ( 3 )$$

where T is the time in seconds, V is the final steady state supercapacitor voltage in Volts, C is the capacitance in Farads, I is the peak current in the primary winding of the flyback transformer in Amperes, L is the inductance of the primary winding of the flyback transformer in Henrys, and N is the frequency of operation of the flyback transformer. Again, in terms of power output P of the power source 210, equation (3) can be written as (assuming 100% efficiency):

$$T = C \times V \times \frac{V}{2 P} . \qquad ( 3 a )$$

As can be seen from (3a) and (2a), the charging time for the supercapacitor 140 drops to half in comparison to when the Current limiter is used.

According to one or more embodiments, a flyback transformer 230 is used that has primary and secondary windings, with a suitable primary inductance of L Henrys, depending on the application. The primary winding is connected to a source of DC voltage 210 with a transistor switch 220 in series. When the switch 220 is closed, the current in the primary winding starts ramping up.

The energy stored in the primary winding is given by:

$$E = \frac{1}{2} \times L \times {I}^{2} \qquad ( 4 )$$

The secondary winding is connected across the supercapacitor 140 with a fast switching diode 240 in series to rectify the current to match the polarity of the supercapacitor 140. When the primary switch 220 is opened, the energy stored in the primary winding is transferred to the secondary winding and causes a brief charging current to flow into the supercapacitor 140. As a consequence, the energy stored in the primary winding is transferred to the supercapacitor 140. This cycle is continuously repeated at a rapid rate, due to the high frequency output of the flyback transformer 230, until the supercapacitor 140 is charged to the desired voltage. Further, using the flyback transformer 230 enables charging the supercapacitor 140 to a voltage higher than the voltage of the DC power source as well, apart from the lower voltage charging only using the conventional method. The amount of energy transferred to the supercapacitor 140 per cycle can be controlled by controlling the peak value attained by the current in the primary winding of the flyback transformer 230. This is done by controlling the “on” period of the switch 220 according to the following equation:

T=LI/V (5),

where T is the “ON” time in seconds of the switch 220, L is the inductance in Henries of the primary winding of the transformer 230, I is the desired peak current in Amperes through the primary winding of the transformer 230 and V is the voltage in volts of the power source 210.

The “ON” time of the switch 220 is determined by the pulse width output 266 of the pulse generator 265. The width of the pulse outputted at 266 can be controlled by the control circuitry 250 via the pulse width control output 253 that connects to the pulse width control input 268 of the pulse generator.

The number of pulses N needed to charge the supercapacitor 140 is determined by:

N=C(V1²−V2²)/LI² (6),

where C is the capacitance in Farads of the supercapacitor 140, V1 is the actual voltage in volts of the supercapacitor 140, V2 is the desired voltage in volts of the supercapacitor 140, L is the inductance in Henrys of the primary winding of the transformer 230, and I is the peak current, in Amperes, through the primary winding of the transformer 230.

In accordance with one or more embodiments of the present invention, the control circuitry 250 can be programmed to perform steps for inductive charging of an electrical energy storage component. In accordance with one embodiment, in a first step, the control circuit 250 measures the voltage across the supercapacitor 140 with the help of the ADC 245, and then in a second step, the control circuit determines the number of pulses needed to charge the supercapacitor 140 to the desired voltage, using equation (6). In a third step, the pulse generator 265 is enabled with the help of the pulse enable input 267, and the pulse generator 265 starts outputting the pulses to the switch 220, through the pulse output 266. The switch 220 turns on for the duration of the pulse and then turns off. In a fourth step, after the required number of pulses have been outputted, the control circuit 250 again measures the voltage of the supercapacitor 140. If the voltage is found to be less than the desired voltage (due to leakage or due to load current being drawn from the supercapacitor 140), then the control circuit 250 again computes the number of pulses needed to charge the supercapacitor 140 to the desired voltage and the second step and the fourth steps are repeated.

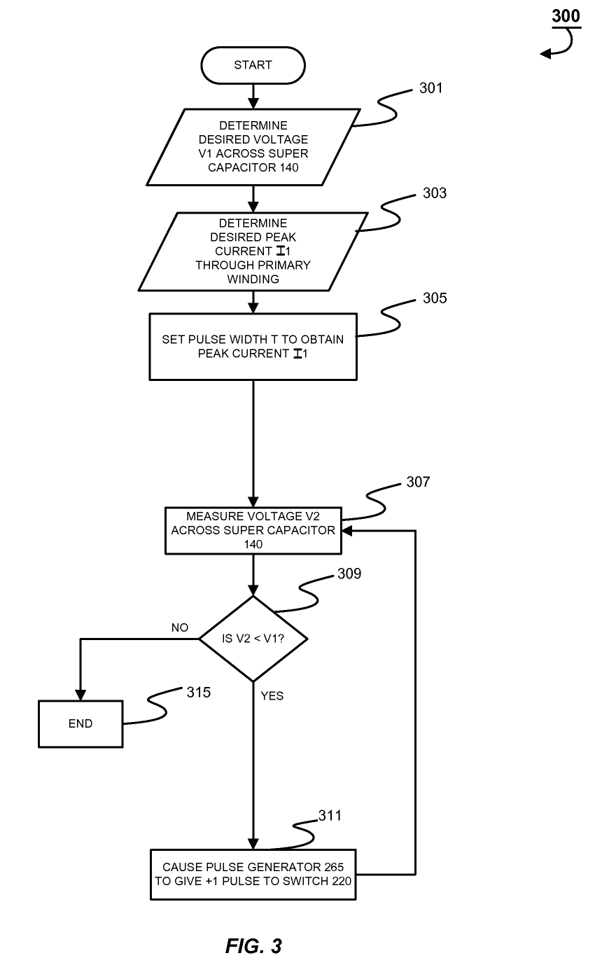

FIG. 3 is a flow chart illustrating operational steps of a first method 500 for inductive charging of an electrical energy storage component, in accordance with one embodiment of the present invention. As described above, control circuitry 250 is programmable to perform the operational steps of the method. As shown, in the first operational step of the method, step 301, a desired voltage for the supercapacitor 140 is determined, and next, at step 303, a desired peak current for the primary winding of the flyback transformer 230 is determined. From step 303, operational flow proceeds to step 305, where a pulse width is set to obtain the desired peak current. Next, at step 307, the voltage V2 across supercapacitor 340 is measured, and then, as shown at step 309, it is determined if the measured voltage V2 is less than the desired voltage V1. If V2 is less than V1, then flow proceeds from step 309 to step 311, where the pulse generator 265 pulses the switch 220, and then after a brief delay to account for decay, operational flow returns to step 307. If it is determined at step 309 that V2 is not less than V1, then the operational flow ends, at step 315.

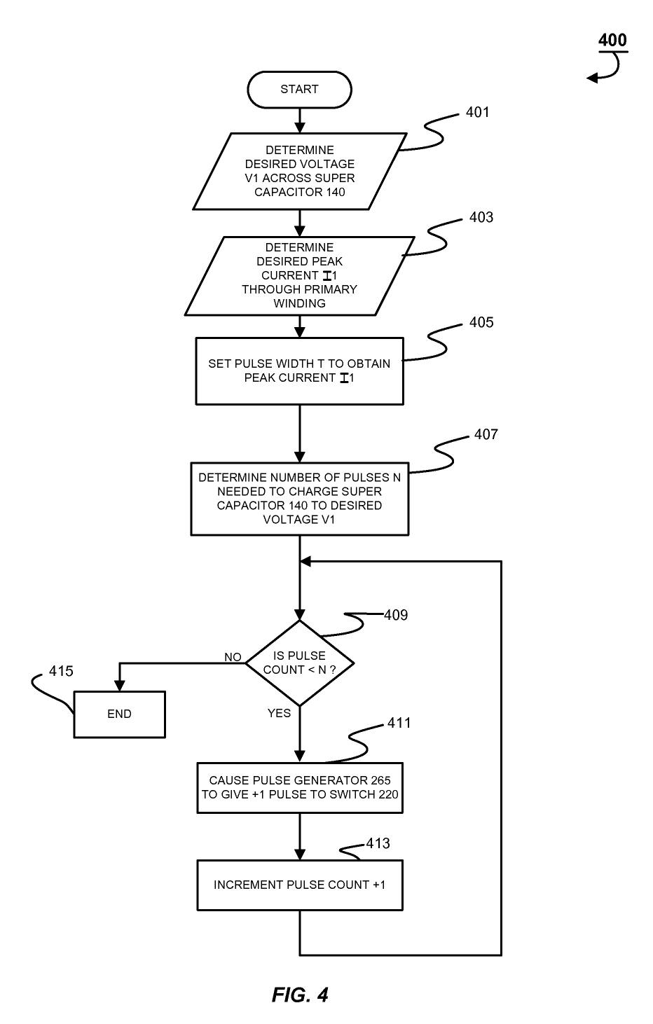

FIG. 4 is a flow chart that illustrates operational steps of a second method 400 for inductive charging of an electrical energy storage component, in accordance with one embodiment of the present invention. As described above, the control circuitry 250 is programmable to perform the operational steps of the method. As shown, in the first operational step of the method, step 401, a desired voltage for the supercapacitor 140 is determined, and next, at step 403, a desired peak current for the primary winding of the flyback transformer 230 is determined. From step 403, operational flow proceeds to step 405, where a pulse width is set to obtain the desired peak current. Next, at step 407, the voltage V2 across supercapacitor 140 is measured, and then, as shown at step 409, the number of pulses N needed to charge the supercapacitor to the desired voltage V1 is determined. Next, the number of pulses that have been given is counted, and if the count is less than the number of pulses needed, N, then the pulse generator 265 pulses the switch 220, then increments the pulse count by one, at step 413, and returns to determine if the pulse count is less than the number of pulses needed, after the switch has been pulsed. If at step 409 it is determined that the pulse count is not less than the number of pulses needed, then operational flow ends, at step 415.

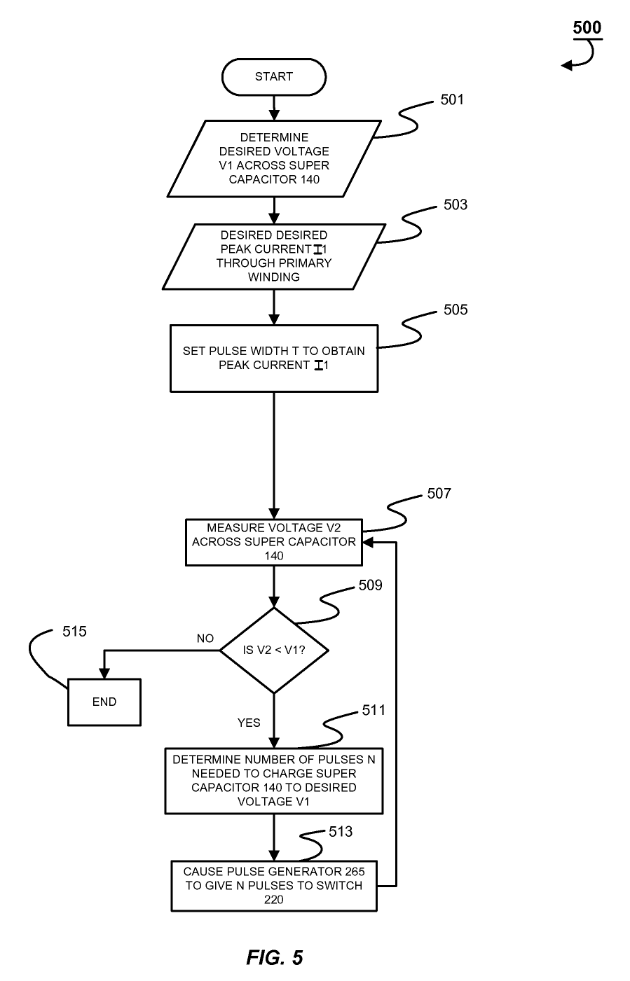

FIG. 5 is a flow chart illustrating operational steps of a third method 500 for inductive charging of an electrical energy storage component, in accordance with one embodiment of the present invention. As described above, the control circuitry 250 is programmable to perform the operational steps of the method. As shown, in the first operational step of the method, step 501, a desired voltage for the supercapacitor 140 is determined, and next, at step 503, a desired peak current for the primary winding of the flyback transformer 230 is determined. From step 503, operational flow proceeds to step 505, where a pulse width is set to obtain the desired peak current. Next, at step 507, the voltage V2 across supercapacitor 140 is measured, and then, as shown at step 509, it is determined if the measured voltage V2 is less than the desired voltage V1. If V2 is less than V1, then flow proceeds from step 509 to step 511, where the number of pulses N needed to charge the supercapacitor 140 to the desired voltage V1 is determined, and then at step 513, the pulse generator 265 pulses the switch 220, and then after a brief delay to account for decay, operational flow returns to step 507. If it is determined at step 509 that V2 is not less than V1, then operational flow ends, at step 515.

Most devices depending on supercapacitors for backup power need some voltage headroom to remain operational, the reason being that a supercapacitor's voltage decays down very slowly in the event of power failure. As a non-limiting example, if a device needs 3.3V to operate, it may use a 6V supercapacitor-based system as backup so that the device remains operational for a long period of time, as the supercapacitor's voltage will decay very slowly from 6V to 3.3V. Further, when the supercapacitor-based system is first powered up and the supercapacitor starts charging, the device does not become operational until the supercapacitor has attained 3.3V. In such systems too, aspects of the present invention provide significant improvement in the time that the system takes to become operational from the moment it is turned on, because of the use of a flyback transformer to charge the supercapacitor at a constant rate of energy transfer, irrespective of the supercapacitor voltage, whereas the rate of energy transfer is very low when the supercapacitor voltage is close to zero for a conventional current limited charger. This phenomenon can be better explained using a non-limiting example that uses a 100 F supercapacitor. If a device becomes operational at 4V and the maximum voltage reached by the supercapacitor is 6V, then using the conventional constant current limited charging method with power output limited to 6 W maximum, the current has to be limited to 1 A. Accordingly, the time required to reach 4V using equation (2) is:

$$100 \times \frac{4}{1} = 400 seconds .$$

Using a method according to an aspects of the present invention, with power output limited to 6 W as above we have from equation (3a), the time required is:

$$100 \times 4 \times 4 \times \frac{2}{6} = 133.33 seconds .$$

As can be seen from this comparison, the device becomes operational in nearly one third of the time that it would take using conventional current limited charging method.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. A system for inductive charging of an electrical energy storage component, comprising:
a power source operative to provide a DC voltage;
a switch operatively connected to the power source;
a transformer having a primary winding and a secondary winding, operatively coupled at the primary winding to the switch and the power source;
a switching diode operatively coupled to the secondary winding of the transformer;
an electrical energy storage component operatively connected to the secondary winding and the switching diode, the switching diode operative to rectify a charging current flowing from the secondary winding to match the polarity of the electrical energy storage component;
a voltage measuring component operatively connected to the electrical energy storage component and switching diode at an input, operative to measure the voltage of the electrical energy storage component and provide a charge level signal;
a programmable controller having a DC voltage input operatively coupled to an output of the ADC, a pulse enable output, and a pulse width control output; and
a pulse generating circuit having a pulse enable input operatively coupled to the pulse enable output of the programmable controller, a pulse output operatively coupled to the switch, and a pulse width control input coupled to the pulse width control output of the programmable controller, the pulse generating circuit responsive to the charge level signal and operative to generate pulses to modulate the switch such that when the switch is closed, current in the primary winding of the transformer ramps up and when the switch is open, energy stored in the primary winding is transferred to the secondary winding of the transformer and the charging current flows into the electrical energy storage component.

2. The system of claim 1, wherein the voltage measuring component comprises an analog-to-digital converter.

3. The system of claim 1, wherein the pulse measuring circuit comprises a pulse generator operative to generate the pulses to modulate the switch.

4. The system of claim 1, further comprising:
a second analog-to-digital converter (ADC) operatively coupled to a current sense input of the programmable controller; and
a current sensing resistor operatively coupled to an analog input of the ADC, the power source, and the transistor, wherein the ADC is operative to measure the voltage across the current sensing resistor.

5. The system of claim 1, wherein the programmable controller is programmed to perform functions comprising:
determining a desired voltage for the electrical energy storage component;
determining a desired peak current for the primary winding of the transformer;
setting a pulse width to obtain the desired peak current;
determining the number of pulses needed to charge the electrical energy storage device to the desired voltage;
determining if the count of the number of pulses given to the electrical energy storage device is less than the number of pulses needed; and
if the count of the number of pulses given is less than the number of pulses needed, causing the pulse generator to pulse the switch, incrementing the pulse count, and returning to determine if the pulse count is less than the number of pulses needed, after the switch has been pulsed.

6. The system of claim 1, wherein the programmable controller is further programmed to control the period of time in which the switch is closed in each pulsing cycle to thereby control the amount of energy transferred to the electrical energy storage component per pulsing cycle.

7. The system of claim 6, wherein controlling the period of time in which the switch is closed in each pulsing cycle comprises controlling the pulse width to thereby control the peak value attained by the current in the primary winding of the transformer.

8. The system of claim 1, wherein the programmable controller is programmed to perform functions comprising:
determining a desired voltage for the electrical energy storage component;
determining a desired peak current for the primary winding of the transformer;
setting a pulse width to obtain the desired peak current;
measuring the voltage across the electrical energy storage component;
if the measured voltage is less than the desired voltage, causing the pulse generator to pulse the switch; and
if the measured voltage is not less than the desired voltage, returning to measure the voltage after the switch has been pulsed.

9. The system of claim 8, wherein the programmable controller is further programmed to control the period of time in which the switch is closed in each pulsing cycle to thereby control the amount of energy transferred to the electrical energy storage component per pulsing cycle.

10. The system of claim 9, wherein controlling the period of time in which the switch is closed in each pulsing cycle comprises controlling the pulse width to thereby control the peak value attained by the current in the primary winding of the transformer.

11. The system of claim 1, wherein the electrical energy storage component is a super capacitor.

12. The system of claim 1, wherein the transformer is a flyback transformer.

13. The system of claim 1, wherein the switch is a transistor switch.

14. A system for inductive charging of an electrical energy storage component, comprising:
a power source operative to provide a DC voltage;
a transistor switch operatively connected to the power source;
a flyback transformer having a primary winding and a secondary winding, operatively coupled to the transistor switch and the power source at the primary winding;
a fast switching diode operatively coupled to the secondary winding of the flyback transformer;
a super capacitor operatively connected to the secondary winding and the fast switching diode, the fast switching diode operative to rectify a charging current flowing from the secondary winding to match the polarity of the flyback transformer;
a first analog-to-digital (ADC) converter operatively connected to the super capacitor and fast switching diode at an analog input, operative to measure the voltage of the super capacitor;
a programmable controller having a DC voltage input operatively coupled to an output of the ADC, a pulse enable output, and a pulse width control output; and
a pulse generator having a pulse enable input operatively coupled to the pulse enable output of the programmable controller, a pulse output operatively coupled to the transistor switch, and a pulse width control input coupled to the pulse width control output of the programmable controller, the pulse generator operative to generate pulses to modulate the transistor switch such as to cause the charging current to flow into the super capacitor.

15. The system of claim 14, further comprising:
a second analog-to-digital converter (ADC) operatively coupled to a current sense input of the programmable controller; and
a sensing resistor operatively coupled an analog input of the second ADC, the power source, and the switching transistor, wherein the second ADC is operative to read the voltage across the current sensing resistor.

16. The system of claim 14, wherein the programmable controller is programmed to perform functions comprising:
determining a desired voltage for the super capacitor;
determining a desired peak current for the primary winding of the flyback transformer;
setting a pulse width to obtain the desired peak current;
measuring the voltage across the super capacitor;
if the measured voltage is less than the desired voltage, causing the pulse generator to pulse the transistor switch; and
if the measured voltage is not less than the desired voltage, returning to measure the voltage after the transistor switch has been pulsed.

17. The system of claim 16, wherein the programmable controller is further programmed to control the period of time in which the switch is closed in each pulsing cycle to thereby control the amount of energy transferred to the electrical energy storage component per pulsing cycle.

18. The system of claim 17, wherein controlling the period of time in which the switch is closed in each pulsing cycle comprises controlling the pulse width to thereby control the peak value attained by the current in the primary winding of the transformer.

19. A system for inductive charging of an electrical energy storage component, comprising:
a power source operative to provide a DC voltage;
a transistor switch operatively connected to the power source;
a flyback transformer having a primary winding and a secondary winding, operatively coupled at the primary winding to the transistor switch and the power source;
a fast switching diode operatively coupled to the secondary winding of the flyback transformer;
a super capacitor operatively connected to the secondary winding and the switching diode, the fast switching diode operative to rectify a charging current flowing from the secondary winding to match the polarity of the super capacitor;
a first analog-to-digital (ADC) converter operatively connected to the super capacitor and switching diode at an input, operative to measure the voltage of the super capacitor;
a programmable controller having a capacitor voltage input operatively coupled to an output of the first ADC, a pulse enable output, and a pulse width control output; and
a pulse generator having a pulse enable input operatively coupled to the pulse enable output of the programmable controller, a pulse output operatively coupled to the transistor switch, and a pulse width control input coupled to the pulse width output of the programmable controller, the pulse generator operative to generate pulses to modulate the transistor switch such as to cause the charging current to flow into the super capacitor.

20. The system of claim 19, further comprising:
a second analog-to-digital converter (ADC) operatively coupled to a current sense input of the programmable controller; and
a current sensing resistor operatively coupled to an input of the second ADC, the power source, and the switching transistor, wherein the second ADC is operative to measure the voltage across the current sensing resistor.

21. The system of claim 19, wherein the programmable controller is programmed to perform functions comprising:
determining a desired voltage for the super capacitor;
determine a desired peak current for the primary winding;
setting a pulse width to obtain the desired peak current;
measure the voltage across the super capacitor;
determine if the voltage across the super capacitor is less than the desired voltage;
if the voltage across the super capacitor is less than the desired voltage, determine the number of pulses needed to charge the super capacitor to the desired voltage, and cause the pulse generator to give the determined number of pulses to the transistor switch, each pulse having pulse width set for obtaining the desired peak current, and return to perform another iteration of measuring the voltage across the super capacitor and determining if the voltage across the super capacitor is less than the desired voltage; and
if the voltage across the super capacitor is not less than the desired voltage, return to measure the voltage across the super capacitor.

22. The system of claim 21, wherein the programmable controller is further programmed to control the pulse width such as to control the period of time in which the transistor switch is closed in each pulsing cycle and thereby control the amount of energy transferred to the super capacitor per pulsing cycle.
